(19) United States
(12) Patent Application Publication
(10) Pub. No.: US 2016/0096965 A1
(43) Pub. Date: Apr. 7, 2016

(54) Phosphate Ester Dispersion Promoting Agent and Dispersion Comprising the Same

(71) Applicant: Valspar Sourcing, Inc., Minneapolis, MN (US)

(72) Inventors: Jin Wang, Foshan City (CN); Gang Duan, Northbrook, IL (US); Jinsong Wen, Foshan City (CN); Kuai Lin, Foshan City (CN); Yinchao Zhang, Foshan City (CN); Hua Lai, Foshan City (CN); Xiahu Chen, Foshan City (CN)

(73) Assignee: Valspar Sourcing, Inc., Minneapolis, MN (US)

(21) Appl. No.: 14/966,136

(22) Filed: Dec. 11, 2015

Related U.S. Application Data
(63) Continuation of application No. PCT/US2014/040605, filed on Jun. 3, 2014.

(30) Foreign Application Priority Data
Jun. 13, 2013 (CN) 201310233774.4

(51) Int. Cl. C09D 7/02; C07F 9/141

(52) U.S. Cl. CPC C09D 7/02; C07F 9/1411

(57) ABSTRACT

This disclosure is directed to a phosphate ester dispersion promoting agent and process for the preparation thereof. The present disclosure also relates to a dispersion of a particulate solid comprising the phosphate ester dispersion promoting agent and use of the phosphate ester dispersion promoting agent for dispersing a particulate solid. The phosphate ester has the structure of formula (I):

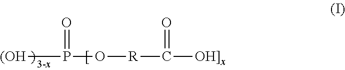

in which
R independently represents, at each occurrence, a polyester residue containing in its skeleton optionally at least one ether oxygen atom —O—; and
x is 1, or 2.

### CROSS-REFERENCE TO RELATED APPLICATION(S)

This application is a continuation of International Application Number PCT/US2014/040605 filed Jun. 3, 2014, which claims priority from Chinese Patent Application No. 201310233774.4 filed 13 Jun. 2013, each of which is incorporated by reference herein in its entirety.

### TECHNICAL FIELD

The present disclosure relates to a phosphate ester dispersion promoting agent and a process for the preparation thereof. The present disclosure also relates to a dispersion of a particulate solid comprising the phosphate ester dispersion promoting agent and use of the phosphate ester dispersion promoting agent for dispersing a particulate solid.

### BACKGROUND

Particulate solids (in particular inorganic particulate solids) have been widely used in various applications including coatings, adhesives, inks, paints, stains, and so on. In particular, particulate solids (for example, pigments and fillers) are an important component of paints and coatings. In preferred embodiments the particulate solids serve to not only provide a good hiding power and a desirable color, but also provide improved physical and chemical properties such as chemical resistance and thermal stability.

Preferred particulate solids that are used as pigment or filler typically have a relatively small particle size, such as a particle size of micrometers or even nanometers. Using such particulate solids often presents a problem in that the particulate solids are prone to aggregate and difficult to homogenously disperse in a dispersing medium.

Dispersion aids may be used to improve the dispersibility of particulate solids so as to form a stable dispersion of the particular solids. Such dispersion aids typically are cationic, anionic, or non-ionic surface active substances. These substances can be directly applied to the particulate solids, or can be added to a dispersion of the particulate solids. The dispersion aids can attach to the surface of the particulate solids, serving to promote dispersion and/or prevent aggregation. It has been known that the dispersion aids suitable for promoting dispersion and/or preventing aggregation of the particulate solids comprise, among others, fat acids, organic silicon compounds, alkanol amines, and polyols.

Currently there is still a need for improved dispersion promoting agents suitable for effectively dispersing particulate solids.

### SUMMARY

In one embodiment, the present disclosure provides a dispersion of a particulate solid dispersed with aid of a novel phosphate ester dispersion promoting agent.

In particular, in one aspect of the present disclosure there is provided a dispersion of a particulate solid, comprising a phosphate ester as a dispersion promoting agent, a particulate solid, a dispersing medium, and optionally one or more additional additives. The phosphate ester has the structure of formula (I):

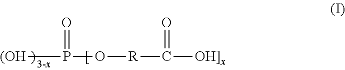

in which R independently represents, at each occurrence, a polyester residue containing in its skeleton optionally at least one ether oxygen atom —O—; and x is 1, or 2.

Preferably, the polyester residue R has a number-average molecular weight in the range of 200 to 1,500 g/mol. More preferably, the ratio by number of the ether oxygen atom, if present, to carboxylate ester groups —COO— in the skeleton is in the range of 1:2 to 3:1.

In an embodiment, the polyester residue R has the structure represented by formula (I-1) or (I-2):

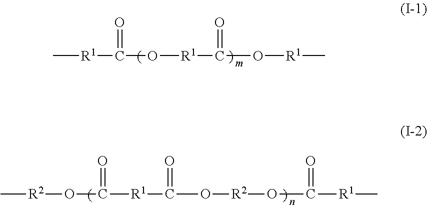

in which each R¹ independently represents, at each occurrence, substituted or unsubstituted C₂-C₁₈ alkylene, substituted or unsubstituted C₂-C₁₈ alkenylidene, or substituted or unsubstituted C₆-C₁₈ arylene; each R² independently represents, at each occurrence, C₂-C₁₈ alkylene; or —(CH₂CH₂O)ₚCH₂CH₂—, in which p is in the range of 1 to 6; or —(CH₂CH₂CH₂O)_{q}CH₂CH₂CH₂—, in which q is in the range of 1 to 6; or —R″O(CH₂CH₂O)ₚ(CH₂CH₂CH₂O)_{q}R″—, where p and q are as defined above, the structural units are connected with each other randomly, and R″ is —CH₂CH₂— or —CH₂CH₂CH₂—; m is in the range of 0 to 100; and n is in the range of 0 to 100.

In an embodiment, the dispersion comprises, relative to the total weight of the dispersion of the particulate solid, 0.5 to 3.0% by weight of the phosphate ester as a dispersion promoting agent; 40 to 80% by weight of the particulate solid; 20 to 40% by weight of the dispersing medium; and 0 to 10% by weight of one or more additional additives.

In another aspect of the present disclosure, there is provided a process for the preparation of a phosphate ester of formula (I) used as a dispersion promoting agent

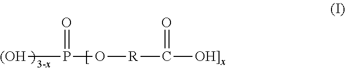

in which R independently represents, at each occurrence, a polyester residue containing in its skeleton optionally at least one ether oxygen atom —O—; and x is 1 or 2. The process comprising: (i) providing at least one hydroxyl compound containing a free carboxylic acid group represented by the general formula (II)

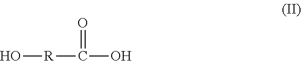

in which R is defined as above; and (ii) performing esterification of the hydroxyl compound with a phosphating agent, thereby forming the phosphate ester used as a dispersion promoting agent.

In an embodiment, the hydroxyl compound is provided by esterification of at least one hydroxycarboxylic acid and/or its lactone, or by esterification of at least one dicarboxylic acid or polycarboxylic acid with at least one diol in a 1:1 or greater molar equivalent ratio of the acid to the diol. Preferably, the hydroxyl compound has the structure represented by formula (II-1) or (II-2)

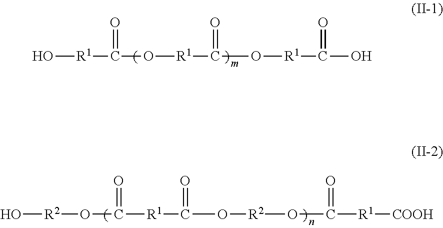

in which each R¹ independently represents, at each occurrence, substituted or unsubstituted C₂-C₁₈ alkylene, substituted or unsubstituted C₂-C₁₈ alkenylidene, or substituted or unsubstituted C₆-C₁₈ arylene; each R² independently represents, at each occurrence, C₂-C₁₈ alkylene; or —(CH₂CH₂O)ₚCH₂CH₂—, in which p is in the range of 1 to 6; or —(CH₂CH₂CH₂O)_{q}CH₂CH₂CH₂—, in which q is in the range of 1 to 6; or —R″O(CH₂CH₂O)ₚ(CH₂CH₂CH₂O)_{q}R″—, where p and q are as defined above, the structural units are connected with each other randomly, and R″ is —CH₂CH₂— or —CH₂CH₂CH₂—; m is in the range of 0 to 100; and n is in the range of 0 to 100.

In still another aspect of the present disclosure, there is provided use of the phosphate ester dispersion promoting agent disclosed herein for dispersing particulate solids. Preferably, the particulate solids may comprise pigments or fillers. More preferably, the particulate solids may comprise inorganic pigments or inorganic fillers, such as metals, alloys, metal oxides, metal salts, oxymetallic compounds, nonmetal oxides, or the like. The specific examples of such particulate solids may comprise titanium dioxide, calcium carbonate, barium sulfate, silicon dioxide, or silicates. Most preferably, the particulate solid may be titanium dioxide, such as titanium dioxide in the form of powder.

The phosphate ester dispersion promoting agent disclosed herein may contain a polyester residue containing in its skeleton optionally at least one ether oxygen atom —O— and further at least one free carboxylic group. The phosphate ester dispersion promoting agent disclosed herein, when used for dispersing a particulate solid, can provide the resultant dispersion with a good thixotropic behavior (i.e., a desirable shear-thinning behavior).

The details of one or more embodiments of the invention will be set forth in the description below. The other features, objectives, and advantages of the invention will become apparent.

### DETAILED DESCRIPTION

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention. All patents, pending patent applications, published patent applications, and technical articles cited herein are incorporated herein by reference in their respective entireties for all purposes.

A group or a polyester residue that may be the same or different is referred to as being “independently” something.

As used herein, the term “polyester residue” refers to a residue derived from a free carboxylic group-containing polyester, which contains in its skeleton optionally at least one ether oxygen atom —O—.

The term “alkylene”, as used with respect to a polyester residue R, refers to a linear, branched, or cyclic divalent saturated hydrocarbyl group that may be substituted or unsubstituted. In case of being substituted, the substituent(s) may preferably include a carboxylic, a carboxylate ester, or a carboxylate salt group. Suitable examples of alkylene may include ethylene, propylene, tetramethylene, pentamethylene, 1,3-dimethyltrimethylene, 2,2-dimethyltrimethylene, 3-methylpentamethylene, cyclohexylene, or 1-isopropyl-2,2-dimethyltrimethylene.

The term “alkenylidene”, as used with respect to a polyester residue R, refers to a linear, branched, or cyclic divalent unsaturated hydrocarbyl group containing at least one carbon-carbon double bond, which may be substituted or unsubstituted. In case of being substituted, the substituent(s) may preferably include a carboxylic, a carboxylate ester, or a carboxylate salt group.

The term “arylene”, as used with respect to a polyester residue R, refers to a divalent aromatic group that may be substituted or unsubstituted. In case of being substituted, the substituent(s) may preferably include a carboxylic, a carboxylate ester, or a carboxylate salt group. A suitable example of arylene may include phenylene that may be unsubstituted or substituted with a carboxyl group.

As used herein, the phrase “a molar equivalent ratio of the acid to the diol” refers to the molar ratio of carboxylic groups of the dicarboxylic acid or polycarboxylic acid to hydroxyl groups of the diol. The term “carboxylic acid,” as used in the context of esterification with a hydroxyl compound, also includes any suitable ester-forming derivative thereof, which can react with a hydroxyl compound to form a carboxylate ester. The suitable ester-forming derivative of a carboxylic acid is known to a person skilled in the art, and may include, but not limited to, an anhydride, an acyl halide, an ester of a carboxylic acid and a lower alkanol, or the like.

Throughout the present disclosure, where compositions are described as having, including, or comprising specific components or fractions, or where processes are described as having, including, or comprising specific process steps, it is contemplated that the compositions or processes as disclosed herein may further comprise other components or fractions or steps, whether or not specifically mentioned in this disclosure, as long as such components or steps do not affect the basic and novel characteristics of the invention, but it is also contemplated that the compositions or processes may consist essentially of, or consist of, the recited components or steps.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a”, “an”, “the”, “at least one”, and “one or more” are used interchangeably. Thus, for example, a dispersion that comprises “a” particulate solid can be interpreted to mean that the dispersion includes “one or more” particulate solids.

For the sake of brevity, only certain ranges are explicitly disclosed herein. However, ranges from any lower limit may be combined with any upper limit to recite a range not explicitly recited, ranges from any lower limit may be combined with any other lower limit to recite a range not explicitly recited, and in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### Phosphate Ester Dispersion Promoting Agent

In one aspect of the present disclosure, there is provided a phosphate ester having formula (I) used as a dispersion promoting agent,

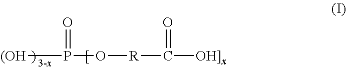

in which

R independently represents, at each occurrence, a polyester residue containing in its skeleton optionally at least one ether oxygen atom —O—; and x is 1 or 2. Preferably, the polyester residue R has a number-average molecular weight in the range of 200 to 1,500 g/mol, more preferably 500 to 1,400 g/mol, and even more preferably 700 to 1,200 g/mol.

In a preferred embodiment, the ratio by number of the ether oxygen atom to carboxylate ester groups —COO— in the skeleton is in the range of 1:2 to 3:1. Preferably, the ratio is about 1:1.

In an embodiment, the polyester residue R that contains in its skeleton optionally at least one ether oxygen atom —O— has the structure represented by formula (I-1) or (I-2):

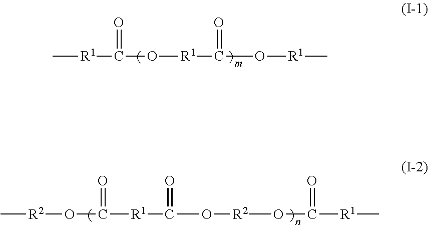

in which

each R¹ independently represents, at each occurrence, substituted or unsubstituted C₂-C₁₈ alkylene, substituted or unsubstituted C₂-C₁₈ alkenylidene, or substituted or unsubstituted C₆-C₁₈ arylene, with the substituent(s) preferably including a carboxylic, a carboxylate ester, or a carboxylate salt group when substituted;

each R² independently represents, at each occurrence, C₂-C₁₈ alkylene; or —(CH₂CH₂O)ₚCH₂CH₂—, in which p is in the range of 1 to 6; or —(CH₂CH₂CH₂O)_{q}CH₂CH₂CH₂—, in which q is in the range of 1 to 6; or —R″O(CH₂CH₂O)ₚ(CH₂CH₂CH₂O)_{q}R″—, where p and q are as defined above, the structural units are connected with each other randomly, and R″ is —CH₂CH₂— or —CH₂CH₂CH₂—;

m is in the range of 0 to 100; and

n is in the range of 0 to 100.

### Preparation of Phosphate Ester Dispersion Promoting Agent

In another aspect of the present disclosure, there is provided a process for the preparation of a phosphate ester of formula (I) used as a dispersion promoting agent

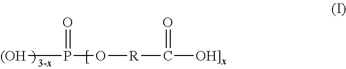

in which

R independently represents, at each occurrence, a polyester residue containing in its skeleton optionally at least one ether oxygen atom —O—; and

x is 1 or 2,

the process comprising:

(i) providing at least one hydroxyl compound containing a free carboxylic acid group represented by the general formula (II)

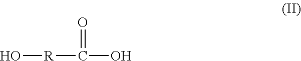

in which

R is defined as above; and

(ii) performing esterification of the hydroxyl compound with a phosphating agent, thereby forming the phosphate ester dispersion promoting agent.

As used herein, the term “phosphating agent”, as used herein, refers to a phosphorus compound which can form a phosphate ester by reaction with a hydroxyl compound. For example, phosphorus oxychloride, phosphorus pentoxide, polyphosphoric acid, pyrophosphoric acid or acetyl phosphate can be used as an example of a phosphating agent. Additional examples can be found in German Patent Application No. DE-A 2,726,854. Phosphorus pentoxide, polyphosphoric acid and pyrophosphoric acid are preferred.

In particular, the phosphate ester as disclosed herein can be prepared by reaction of one phosphoric acid equivalent of a phosphating agent with one or two equivalents of a hydroxyl compound represented by the general formula (II) as defined above. The reaction can be carried out as described, for example, in U.S. Pat. No. 4,183,766 and in Houben-Weyl, “Methoden der Organischen Chemie” Vol. XII/2, 4^{th} edition page 143. As used with respect to a phosphating agent, the phrase “one phosphoric acid equivalent” means that the phosphating agent can react with one or two equivalents of a hydroxyl compound represented by the general formula (II) stoichiometrically to form a phosphoric acid monoester or diester represented by the general formula (I) as indicated above.

Where one equivalent of a hydroxyl compound is used in relation to one phosphoric acid equivalent of a phosphating agent, a phosphoric acid monoester is expected to form stoichiometrically. Where two equivalents of a hydroxyl compound are used in relation to one phosphoric acid equivalent of a phosphating agent, a phosphoric acid diester is expected to form stoichiometrically. Intermediate ratios (i.e., between one and two equivalents of hydroxyl compound) may also be used and a mixture of monoester and diester species will be formed.

According to the present disclosure, polyester residues R'sin a phosphate ester of formula (I) may be the same or different. A phosphate ester of formula (I) having different polyester residues R's can be prepared, for example, by first reacting 1 phosphoric acid equivalent of a phosphating agent with 1 equivalent of a hydroxyl compound to form a monoester, then reacting the resulting monoester with 1 equivalent of a hydroxyl compound having a different polyester residue R. A phosphate ester of formula (I) having different polyester residues R's can also be prepared by reacting 1 phosphoric acid equivalent of a phosphating agent with a mixture of hydroxyl compounds having different polyester residues R's.

A person skilled in the art can determine the suitable conditions for the reaction of a phosphating agent with a hydroxyl compound according to the types of phosphating agent and hydroxyl compound used, including use of solvent, reaction temperature, and so on. Preferably, the reaction is carried out at a temperature of at most 100° C. in absence of any solvent. Alternately, the reaction can be carried out in presence of a suitable inert solvent as described in, for example, EP-A 193019.

In an embodiment, providing the hydroxyl compound containing a free carboxylic acid group comprises providing a hydroxyl compound containing a free carboxylic acid group having the structure represented by formula (II-1) or (II-2) by esterification of at least one hydroxycarboxylic acid and/or its lactone, or by esterification of at least one dicarboxylic acid or polycarboxylic acid with at least one diol in a 1:1 or greater molar equivalent ratio of the acid to the diol:

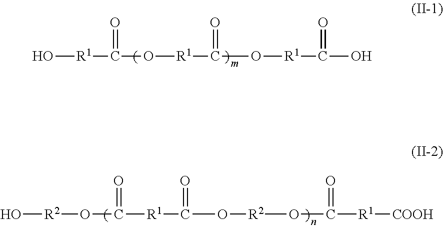

wherein R¹, R², m, and n are defined as above.

Preferably, the hydroxyl compound has a number-average molecular weight in the range of 200 to 1,500 g/mol, more preferably 500 to 1,400 g/mol, and even more preferably 700 to 1,200 g/mol. The number-average molecular weight can be determined by an acid value of the hydroxyl compound.

For the preparation of a hydroxyl compound of formula (II-1), hydroxycarboxylic acid and/or its lactone may be used as the starting material.

Suitable hydroxycarboxylic acids include: 12-hydroxystearic acid, ricinoleic acid, 12-hydroxydodecanoic acid, 5-hydroxydodecanoic acid, 5-hydroxydecanoic acid, 4-hydroxydecanoic acid, glycolic acid, lactic acid, 6-hydroxyhexanoic acid and 5-hydroxypentanoic acid. Preferably, ricinoleic acid or 12-hydroxystearic acid are used as the hydroxycarboxylic acid.

Suitable lactones include: propiolactone, butyrolactone, δ-valerolactone, ε-caprolactone, and C₁₋₈ alkyl substituted ε-caprolactone. Preferably, ε-caprolactone is used as the lactone.

The esterification reaction of hydroxycarboxylic acid and/or its lactone can be effected under conditions that are known in the art. For example, the esterification reaction can be effected in the presence of a catalyst such as p-toluenesulfonic acid, dibutyltin dilaurate or tetrabutyl titanate at a temperature ranging from about 80° C. to about 180° C.

In an embodiment, the esterification reaction of 12-hydroxystearic acid as the hydroxycarboxylic acid and ε-caprolactone as the lactone is carried out in the presence of a catalyst at an elevated temperature. For example, 12-hydroxystearic acid and ε-caprolactone may be used as the starting materials and provided in a 1:1 molar equivalent ratio of carboxyl group to hydroxyl group for the esterification, thereby forming a hydroxyl compound containing a free carboxylic acid group.

Without wishing to be bound by any theory, in the embodiment wherein 12-hydroxystearic acid is used as the hydroxycarboxylic acid and ε-caprolactone as the lactone, it is believed that the esterification reaction proceeds as illustrated in the following scheme:

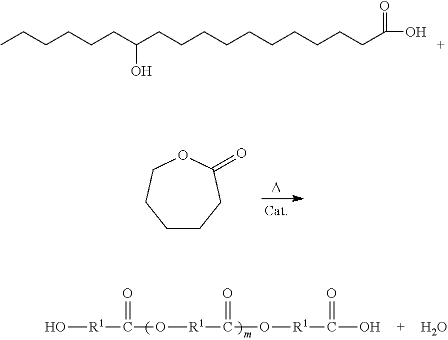

in which each R¹ independently represents, at each occurrence, —CH(CH₂CH₂CH₂CH₂CH₂CH₃)—(CH₂)₁₀— or —(CH₂)₅—; and m is in the range of 0 to 100.

Preferably, the reaction is carried out in a solvent of xylene in the presence of a catalyst of tetrabutyl titanate at an elevated temperature up to 180° C. Water is removed from the reaction system while the reaction is proceeding.

For the preparation of a hydroxyl compound of formula (II-2), dicarboxylic acid or polycarboxylic acid and diol may be used as the starting material. Typically the molar equivalent ratio of dicarboxylic acid or polycarboxylic acid to diol is 1:1 or greater. Preferably, the molar equivalent ratio of dicarboxylic acid or polycarboxylic acid to diol is in the range of 1:1 to 1.2:1.

Dicarboxylic acid or polycarboxylic acid can also be used in the form of its ester-forming derivative. Preferably, the acid is used in the form of anhydride. For example, trimellitic anhydride (TMA) or 4-carboxyl phthalic anhydride can be used. As an example of dicarboxylic acid or polycarboxylic acid (or its ester-forming derivative) used herein, oxalic acid, malonic acid, succinic acid, glutaric acid, adipic acid, sebacic acid, trimellitic anhydride, or combination thereof can be given. Preferably, adipic acid, sebacic acid, trimellitic anhydride or combination thereof is used.

Suitable diols used herein include, neopentyl glycol, 1,6-hexylene glycol, 3-methyl-1,5-pentanediol, 1,4-cyclohexane dimethanol, 2,2,4-trimethyl-1,3-pentanediol, ethylene glycol, diethylene glycol, triethylene glycol, tetraethylene glycol, hexaethylene glycol, propylene glycol, tripropylene glycol, or combination thereof. Preferably, neopentyl glycol, 1,6-hexylene glycol, triethylene glycol, tripropylene glycol, or a combination thereof is used. More preferably, triethylene glycol or tripropylene glycol is used.

The esterification reaction of dicarboxylic acid or polycarboxylic acid (or its ester-forming derivative) with diol can be effected under the conditions that are known in the art. For example, the esterification reaction can be effected by removing water under azeotropic distillation in the absence of any catalyst.

In an embodiment, adipic acid is used as the dicarboxylic acid, and neopentyl glycol and 1,6-hexylene glycol are used as the diol. Preferably, the esterification reaction of adipic acid with neopentyl glycol and 1,6-hexylene glycol is effected by removing water under azeotropic distillation at an elevated temperature. Adipic acid used as the dicarboxylic acid and neopentyl glycol and 1,6-hexylene glycol used as the diol are loaded, respectively, in such an amount that the molar equivalent ratio of the dicarboxylic acid to the diol is in the range of 1:1 to 1.2:1, in particular 1:1, thereby forming a hydroxyl compound containing a free carboxylic acid group.

Without wishing to be bound by any theory, in the embodiment wherein adipic acid is used as the dicarboxylic acid and neopentyl glycol and 1,6-hexylene glycol are used as the diol, it is believed that the esterification reaction proceeds as illustrated in the following scheme:

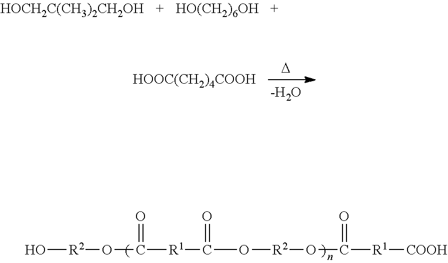

in which

each R¹ independently represents, at each occurrence, —(CH₂)₄—;

each R² independently represents, at each occurrence, —CH₂C(CH₃)₂CH₂— or —(CH₂)₆—; and

n is in the range of 0 to 100.

Preferably, the reaction is carried out in a solvent of xylene in the absence of any catalyst at an elevated temperature up to 160° C. Water is removed from the reaction system while the reaction is proceeding.

The phosphate ester dispersion promoting agent according to the present disclosure can be prepared by the process as disclosed herein. The phosphate ester dispersion promoting agent as prepared can be applied directly to intended applications, such as formulation of stain or paint.

### Application of Phosphate Ester Dispersion Promoting Agent

In still another aspect of the present disclosure, there is provided a dispersion of a particulate solid comprising the phosphate ester dispersion promoting agent as disclosed herein and use of the phosphate ester dispersion promoting agent for dispersing a particulate solid. In the context of the present disclosure, a dispersion of a particulate solid refers to a composition of matter obtained by dispersing a particulate solid in a dispersing medium with the aid of a dispersion promoting agent.

In an embodiment, a dispersion of a particulate solid comprises a phosphate ester dispersion promoting agent as disclosed herein, a particulate solid, a dispersing medium, and optionally one or more additional additives.

The dispersion may comprise, relative to the total weight of the dispersion, 0.5 to 3.0% by weight, preferably 0.5 to 2.0% by weight, more preferably 0.7 to 1.5% by weight, and most preferably 0.8 to 1.0% by weight, of the phosphate ester dispersion promoting agent.

As used herein, the term “particulate solid” refers to any solid material which is substantially insoluble in a dispersion medium at the temperature concerned, and which it is desired to stabilize in a finely divided form in the dispersion medium. The particulate solid may be in shape of sphere, fiber, flake, or other regular or irregular shapes of micrometric or even nanometric size.

Examples of a particulate solid comprise pigments and fillers, especially those pigments or fillers suitably used in a stain, paint or coating.

In an embodiment, the particulate solid is selected from inorganic pigments comprising metal oxides such as titanium dioxide, iron oxides, zinc oxide, zirconia, or aluminia; metal composite oxides containing two or more metal elements including manganese, nickel, titanium, chromium, antimony, magnesium, cobalt, iron, or aluminum; oxymetallic compounds, such as bismuth vanadate, cobalt aluminate, cobalt zincate, or zinc chromate; metallic pigments, such as aluminum flake, copper, and copper-zinc alloys; and pearlescent pigments, such as lead carbonate and bismuth oxychloride.

In another embodiment, the particulate solid is selected from the group of inorganic fillers comprising calcium carbonate, calcium sulfate, calcium oxide, calcium oxalate, calcium phosphate, calcium phosphonate, barium sulfate, barium carbonate, magnesium oxide, magnesium hydroxide, aluminum trihydrate, silica (including natural amorphous silica, natural crystalline silica, natural diatomaceous earth, precipitated silica, fumed silica and nano-silica), silicates (including talc, kaolin, wollastonite, mica, sericite, synthetic aluminum silicate), metal fibers, glass fibers, carbon black, and the like.

In a specific embodiment, the particulate solid is titanium dioxide in the form of a powder.

The dispersion may comprise, relative to the total weight of the dispersion, 40 to 80% by weight, preferably 50 to 80% by weight, more preferably 55 to 70% by weight, and most preferably 55 to 65% by weight, of the particulate solid.

As used herein, the term “dispersing medium” refers to a medium in which the particulate solid is dispersed. Preferably, the dispersing medium is a polar organic liquid or resin or a non-polar organic liquid. Suitable examples of the polar organic liquid include, but are not limited to, dialkyl ketones, alkyl esters of alkanoic acid and alkanol, and the like. As examples of the preferred polar organic liquids there may be mentioned dialkyl and cycloalkyl ketones, such as acetone, methyl ethyl ketone, diethyl ketone, di-isopropyl ketone, methyl isobutyl ketone, di-isobutyl ketone, methyl isoamyl ketone, methyl n-amyl ketone and cyclohexanone; alkyl esters, such as methyl acetate, ethyl acetate, isopropyl acetate, butyl acetate, ethyl formate, methyl propionate, methoxy propylacetate, and ethyl butyrate; glycols and glycol esters and ethers, such as ethylene glycol, 2-ethoxyethanol, 3-methoxypropylpropanol, 3-ethoxypropylpropanol, 2-butoxyethyl acetate, 3-methoxypropyl acetate, 3-ethoxypropyl acetate, and 2-ethoxyethyl acetate; alkanols, such as methanol, ethanol, n-propanol, isopropanol, n-butanol and isobutanol; and dialkyl and cyclic ethers, such as diethyl ether and tetrahydrofuran.

A polar resin may also be used as the dispersing medium of the dispersion according to the present disclosure. Suitable examples thereof are those film-formation resins suitably used in inks, paints or coatings. The specific examples of such resins include, among others, polyamides, such as Versamid™ and Wolfamid™; cellulose ethers, such as ethyl cellulose and ethyl hydroxyethyl cellulose; and alkyd resins, such as short oil alkyd resins and long oil alkyd resins.

Suitable examples of the non-polar, organic liquid include, among others, non-halogenated aromatic hydrocarbons, such as toluene and xylene; halogenated aromatic hydrocarbons, such as chlorobenzene, dichlorobenzene and trichlorobenzene; non-halogenated aliphatic hydrocarbons, such as those saturated or partially saturated, linear or branched hydrocarbons containing 6 or more carbon atoms; halogenated aliphatic hydrocarbons, such as dichloromethane, carbon tetrachloride, chloroform, trichloroethane; and natural non-polar organic liquids, such as vegetable oils, sunflower oil, linseed oil, terpene, and glyceride.

Preferably, a polar organic liquid or a polar resin is used as the dispersing medium. In this case, the phosphate ester dispersion promoting agent according to the present disclosure will have good compatibility with the dispersing medium, thereby allowing the particulate solid to disperse in the dispersing medium even better.

In an embodiment, the dispersion may comprise, relative to the total weight of the dispersion, 20 to 40% by weight, preferably 25 to 35% by weight, of the dispersing medium.

The dispersion of a particulate solid may further comprise one or more additional additives. Suitable examples of the additional additive for the dispersion comprise surface active agents, antifoaming agents, rheology modifying agents, thermal stabilizers, flow/leveling agents, matting agents, anti-sedimentation agents, biocides, and combination thereof.

In the dispersion of a particulate solid according to the present disclosure, the amounts and types of additional additives desirably used can be determined empirically by a person skilled in the art. In an embodiment, the total amount of one or more additives is in the range of 0 to 10% by weight relative to the total weight of the dispersion.

The dispersion of a particulate solid as disclosed herein can be used directly as such or can be used to formulate paints or coating compositions.

The dispersion of a particulate solid that is formulated with aid of the phosphate ester dispersion promoting agent disclosed herein and the coating compositions comprising the dispersion exhibit a desirable shear-thinning behavior.

### EXAMPLES

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available, and used directly as they were originally received.

### Example 1

### Preparation of Hydroxyl Compounds

Hydroxyl Compound 1

Under the protection of N₂, 146.14 parts of adipic acid, 52.07 parts of neopentyl glycol, 59.08 parts of hexane glycol and 20.6 parts of xylene were loaded into a four-necked flask equipped with a thermometer, an overhead stirrer, a gas inlet, a condenser with a Dean-Stark trap, and then were homogenized. The reaction mixture melt after heated to about 120° C., and the stirring was started. Thereafter, the mixture was heated to 160° C., and was held at that temperature. Water resulting from the reaction was removed from the reaction mixture via azeotropic distillation. When the acid value of the reaction mixture arrived at about 59.1 mg KOH/g reaction mixture, the reaction was stopped. The solvent was removed via distillation under reduced pressure, whereby the product of the reaction (Hydroxyl Compound 1 that contains a free carboxylic acid group) was obtained. After calculation, its number-average molecular weight was determined to be about 850 g/mol.

### Hydroxyl Compound 2

Hydroxyl Compound 2 was prepared according to the similar procedure for the preparation of Hydroxyl Compound 1, except that 59.08 parts of 3-methyl-1,5-pentanediol was used to replace hexane glycol, and the reaction was stopped when the acid value arrived at about 59.1 mg KOH/g reaction mixture. Hydroxyl Compound 2 that contains a free carboxylic acid group was obtained. After calculation, its number-average molecular weight was determined to be about 850 g/mol.

### Hydroxyl Compound 3

Hydroxyl Compound 3 was prepared according to the similar procedure for the preparation of Hydroxyl Compound 1, except that 202.25 parts of sebacic acid were used to replace adipic acid, and the reaction was stopped when the acid value arrived about 69 mg KOH/g reaction mixture. Hydroxyl Compound 3 that contains a free carboxylic acid group was obtained. After calculation, its number-average molecular weight was determined to be about 730 g/mol.

### Hydroxyl Compound 4

Under the protection of N₂, 146.14 parts of adipic acid, 112.65 parts of triethylene glycol, 40.06 parts of tripropylene glycol, and 29.8 parts of xylene were loaded into a four-necked flask reactor equipped with a thermometer, an overhead stirrer, a gas inlet, and a condenser with a Dean-Stark trap at room temperature, and then were homogenized. Afterwards the reaction mixture was heated to about 150° C. under stirring, and was held at this temperature. Water resulting from the reaction was removed from the reaction mixture via azeotropic distillation. When the acid value arrived at about 56.7 mg KOH/g reaction mixture, the reaction was stopped. The solvent was removed via distillation under reduced pressure, whereby the product of the reaction (Hydroxyl Compound 4 that contains a free carboxylic acid group) was obtained. After calculation, its number-average molecular weight was determined to be about 890 g/mol.

### Hydroxyl Compound 5

Under the protection of N₂, 298.8 parts of ricinoleic acid, 411.4 parts of ε-caprolactone, 70 parts of xylene, and 0.7 parts of tetrabutyl titanate were loaded into a four-necked flask reactor equipped with a thermometer, an overhead stirrer, a gas inlet, and a condenser with a Dean-Stark trap at room temperature, and then were homogenized. Afterwards the reaction mixture was heated to about 180° C. under stirring, and was held at this temperature. Water resulting from the reaction was removed from the reaction mixture via azeotropic distillation. When the acid value arrived at about 45.3 mg KOH/g reaction mixture, the reaction was stopped. The solvent was removed via distillation under reduced pressure, whereby the product of the reaction (Hydroxyl Compound 5 that contains a free carboxylic acid group) was obtained. After calculation, its number-average molecular weight was determined to be about 1120 g/mol.

### Hydroxyl Compound 6

Hydroxyl Compound 6 was prepared according to the similar procedure for the preparation of Hydroxyl Compound 5, except that 300.48 parts of 12-hydroxystearic acid was used to replace ricinoleic acid, and the reaction was stopped when the acid value arrived about 45 mg KOH/g reaction mixture. Hydroxyl Compound 6 that contains a free carboxylic acid group was obtained. After calculation, its number-average molecular weight was determined to be about 1120 g/mol.

### Hydroxyl Compound 7

Under the protection of N₂, 58.46 parts of adipic acid, 31.24 parts of neopentyl glycol, 23.63 parts of 1,6-hexylene glycol, 19.3 parts of trimellitic anhydride, and 11.2 parts of xylene were loaded into a four-necked flask reactor equipped with a thermometer, an overhead stirrer, a gas inlet, and a condenser with a Dean-Stark trap at room temperature, and then were homogenized. Afterwards the reaction mixture was heated to about 180° C. under stirring, and was held at this temperature. Water resulting from the reaction was removed from the reaction mixture via azeotropic distillation. When the acid value arrived at about 107.3 mg KOH/g reaction mixture, the reaction was stopped. The solvent was removed via distillation under reduced pressure, whereby the product of the reaction (Hydroxyl Compound 7 that contains a free carboxylic acid group) was obtained. After calculation, its number-average molecular weight was determined to be about 950 g/mol.

### Preparation of Phosphate Esters

### Phosphate Ester 1

Under the protection of N₂, 100 parts of Hydroxyl Compound 1 were loaded into a reaction vessel at room temperature. 7.2 parts of phosphorus pentoxide were added at a temperature of 35° C., and the reaction mixture was rapidly stirred for 30 minutes. Afterwards the reaction mixture was heated to 90° C. and held at this temperature for 8 hours. Thus Phosphate Ester 1 was obtained.

### Phosphate Esters 2-10

Phosphate Esters 2-10 were prepared according to the similar procedure for the preparation of Phosphate Ester 1, except that the hydroxyl compounds and the phosphating agents were used as listed in Table 1.

TABLE 1

| Phos- | | | | |
|---|---|---|---|---|
| phate | | Parts | | Parts |
| Ester | Hydroxyl Compound | (by wt.) | Phosphating Agent | (by wt.) |
| 2 | Hydroxyl Compound 1 | 100 | polyphosphoric acid | 10.7 |
| 3 | Hydroxyl Compound 2 | 100 | polyphosphoric acid | 12.5 |
| 4 | Hydroxyl Compound 3 | 100 | pyrophosphoric acid | 9.85 |
| 5 | Hydroxyl Compound 4 | 100 | phosphorus pentoxide | 6.45 |
| 6 | Hydroxyl Compound 5 | 100 | phosphorus pentoxide | 5.88 |
| 7 | Hydroxyl Compound 6 | 100 | phosphorus pentoxide | 6.16 |
| 8 | Hydroxyl Compound 7 | 100 | phosphorus pentoxide | 6.12 |
| 9 | Hydroxyl Compound 5 | 100 | pyrophosphoric acid | 6.47 |
| 10 | Hydroxyl Compound 7 | 100 | polyphosphoric acid | 8.26 |

### Example 2

### Dispersion of Particulate Solid and its Thixotropic Behavior

Phosphate ester dispersion promoting agents 2, 4, and 6 (50 solids %) prepared in Example 1 were mixed with short oil alkyd resin (60 solids %), titanium dioxide powder and propylene glycol methoxy acetate (PGMA), respectively, in amounts as shown in Table 2, and were dispersed in Dispermat with glass beads for 1 hour, thus providing the dispersions of a particulate solid named Dispersion 2, Dispersion 4, and Dispersion 6. Additionally, the conventional phosphate ester dispersion promoting agent commercially available under the trade name BYK110 (50 solids %) was used to formulate a control dispersion with the ingredients according to Table 2.

TABLE 2

| | | Disper- | Disper- | Disper- |
|---|---|---|---|---|
| Ingredients | Control | sion 2 | sion 4 | sion 6 |
| BYK110 (50%)/g | 5.4 | | | |
| Phosphate Ester 2/g | | 5.4 | | |
| Phosphate Ester 4/g | | | 5.4 | |
| Phosphate Ester 6/g | | | | 5.4 |
| Titanium dioxide powder (R706)/g | 180 | 180 | 180 | 180 |
| Short oil alkyd resin (60%)/g | 90 | 90 | 90 | 90 |
| PGMA/g | 24.6 | 24.6 | 24.6 | 24.6 |

Measurement Results

| | | | | | |
|---|---|---|---|---|---|
| Viscosity* | 3 rpm | 8838 | 6399 | 6201 | 5824 |
| (mPa · s@25° C.) | 12 rpm | 9118 | 5354 | 5411 | 5012 |

| | | | | |
|---|---|---|---|---|
| Thixotropic Behavior | 1.03 | 0.84 | 0.87 | 0.86 |
| (η₁₂ᵣₚₘ/η₃ᵣₚₘ) | | | | |

*The viscosity of the dispersions was measured with Brookfield LVDV-I Prime Viscometer using the #3 spindle.

The results shown above in Table 2 clearly indicated that the dispersions comprising the inventive phosphate ester dispersion promoting agents exhibited improved shear-thinning property over the control dispersion.

### Example 3

### Paint and its Thixotropic Behavior

Dispersions 2, 4, and 6 produced in Example 2 were mixed, as a stain, with short oil alkyd resin (60 solids %), butyl acetate, and the antifoaming agent, respectively, in amounts as shown in Table 3 in a high-speed disperser at 2000 rpm, thus providing the paints named Paint 2, Paint 4, and Paint 6. Additionally, the control dispersion was used to formulate a control paint with the ingredients according to Table 3.

TABLE 3

| Ingredients | Control | Paint 2 | Paint 4 | Paint 6 |
|---|---|---|---|---|
| Control Dispersion/g | 55 | | | |
| Dispersion 2/g | | 55 | | |
| Dispersion 4/g | | | 55 | |
| Dispersion 6/g | | | | 55 |
| Short oil alkyd resin(60%)/g | 41 | 41 | 41 | 41 |
| Butyl acetate/g | 3.5 | 3.5 | 3.5 | 3.5 |
| Antifoaming agent/g | 0.5 | 0.5 | 0.5 | 0.5 |

Measurement Results

| | | | | | |
|---|---|---|---|---|---|
| Viscosity* | 3 rpm | 7919 | 5959 | 5235 | 5010 |
| (mPa · s@25° C.) | 12 rpm | 7892 | 5039 | 4325 | 4024 |

| | | | | |
|---|---|---|---|---|
| Thixotropic Behavior | 0.99 | 0.85 | 0.83 | 0.80 |
| (η₁₂ᵣₚₘ/η₃ᵣₚₘ) | | | | |

*The viscosity of the paints was measured with Brookfield LVDV-I Prime Viscometer using the #3 spindle.

The results shown above in Table 3 clearly indicated that the paints comprising the inventive phosphate ester dispersion promoting agents exhibited improved shear-thinning property over the control paint.

1. A dispersion of a particulate solid, comprising a phosphate ester as a dispersion promoting agent, a particulate solid, and a dispersing medium, wherein the phosphate ester has the structure of formula (I): 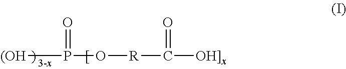
in which
R independently represents, at each occurrence, a polyester residue containing in its skeleton optionally at least one ether oxygen atom —O—; and
x is 1, or 2.

2. The dispersion according to claim 1, wherein the polyester residue R has a number-average molecular weight in the range of 200 to 1500 g/mol.

3. The dispersion according to claim 1, wherein the ratio by number of the ether oxygen atom if present to carboxylate ester groups —COO— in the skeleton is in the range of 1:2 to 3:1.

4. The dispersion according to claim 1, wherein the polyester residue R has the structure represented by formula (I-1) or (I-2): 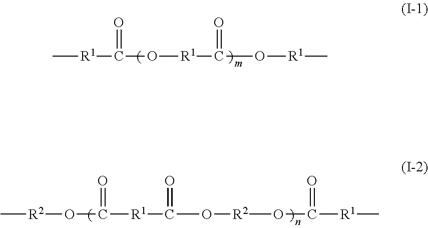
in which
each R¹ independently represents, at each occurrence, substituted or unsubstituted C₂-C₁₈ alkylene, substituted or unsubstituted C₂-C₁₈ alkenylidene, or substituted or unsubstituted C₆-C₁₈ arylene;
each R² independently represents, at each occurrence, C₂-C₁₈ alkylene; —(CH₂CH₂O)ₚCH₂CH₂—, in which p is in the range of 1 to 6; or —(CH₂CH₂CH₂O)_{q}CH₂CH₂CH₂—, in which q is in the range of 1 to 6; or —R″O(CH₂CH₂O)ₚ(CH₂CH₂CH₂O)_{q}R″—, where p and q are as defined above, the structural units are connected with each other randomly, and R″ is —CH₂CH₂—or —CH₂CH₂CH₂—;
m is in the range of 0 to 100; and
n is in the range of 0 to 100.

5. The dispersion according to any one of claims 1 to 3, wherein the phosphate ester is prepared by
(i) providing at least one hydroxyl compound containing a free carboxylic acid group represented by formula (II) 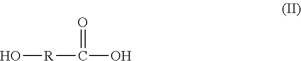
in which
R independently represents, at each occurrence, a polyester residue containing in its skeleton optionally at least one ether oxygen atom —O—; and
(ii) performing esterification of the hydroxyl compound with a phosphating agent, thereby forming the phosphate ester.

6. The dispersion according to claim 5, wherein the hydroxyl compound has the structure represented by formula (II-1) or (II-2): 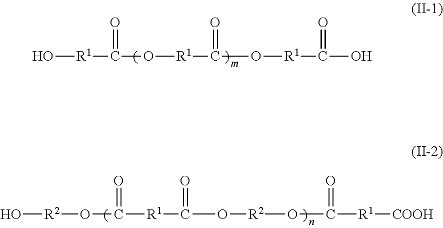
in which
each R¹ independently represents, at each occurrence, substituted or unsubstituted C₂-C₁₈ alkylene, substituted or unsubstituted C₂-C₁₈ alkenylidene, or substituted or unsubstituted C₆-C₁₈ arylene;
each R² independently represents, at each occurrence, C₂-C₁₈ alkylene; —(CH₂CH₂O)ₚCH₂CH₂—, in which p is in the range of 1 to 6; or —(CH₂CH₂CH₂O)_{q}CH₂CH₂CH₂—, in which q is in the range of 1 to 6; or —R″O(CH₂CH₂O)ₚ(CH₂CH₂CH₂O)_{q}R″—, where p and q are as defined above, the structural units are connected with each other randomly, and R″ is —CH₂CH₂— or —CH₂CH₂CH₂—;
m is in the range of 0 to 100; and
n is in the range of 0 to 100.

7. The dispersion according to claim 5, wherein the phosphating agent is selected from the group consisting of phosphorus oxychloride, phosphorus pentoxide, polyphosphoric acid, pyrophosphoric acid and combination thereof.

8. The dispersion according to claim 1, wherein the particulate solid comprises pigments or fillers.

9. The dispersion according to claim 8, wherein the particulate solid comprises metals, alloys, metal oxides, metal salts, silicon dioxide, or silicates.

10. The dispersion according to claim 9, wherein the particulate solid is titanium dioxide in the form of powder.

11. The dispersion according to claim 1, wherein the dispersing medium comprises polar organic liquids, polar resins, or non-polar organic liquids.

12. The dispersion according to claim 1, comprising, relative to the total weight of the dispersion of the particulate solid,
5 to 3.0% by weight of the phosphate ester as a dispersion promoting agent;
40 to 80% by weight of the particulate solid;
20 to 40% by weight of the dispersing medium; and
0 to 10% by weight of one or more additional additives.

13. A phosphate ester having formula (I) used as a dispersion promoting agent, 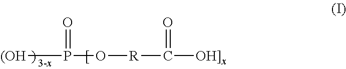
in which
R independently represents, at each occurrence, a polyester residue containing in its skeleton optionally at least one ether oxygen atom —O—; and
x is 1, or 2.

14. The phosphate ester used as a dispersion promoting agent according to claim 13, wherein the polyester residue R has a number-average molecular weight in the range of 200 to 1500 g/mol.

15. The phosphate ester used as a dispersion promoting agent according to claim 13, wherein the ratio by number of the ether oxygen atom if present to carboxylate ester groups —COO— in the skeleton is in the range of 1:2 to 3:1.

16. The phosphate ester used as a dispersion promoting agent according to claim 13, wherein the polyester residue R has the structure represented by formula (I-1) or (I-2): 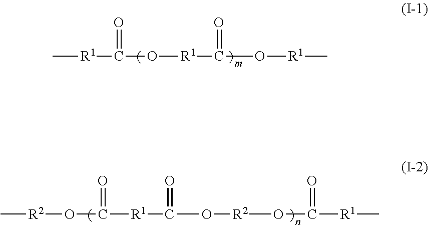
in which
each R¹ independently represents, at each occurrence, substituted or unsubstituted C₂-C₁₈ alkylene, substituted or unsubstituted C₂-C₁₈ alkenylidene, or substituted or unsubstituted C₆-C₁₈ arylene;
each R² independently represents, at each occurrence, C₂-C₁₈ alkylene; —(CH₂CH₂O)ₚCH₂CH₂—, in which p is in the range of 1 to 6; or —(CH₂CH₂CH₂O)_{q}CH₂CH₂CH₂—, in which q is in the range of 1 to 6; or —R″O(CH₂CH₂O)ₚ(CH₂CH₂CH₂O)_{q}R″—, where p and q are as defined above, the structural units are connected with each other randomly, and R″ is —CH₂CH₂— or —CH₂CH₂CH₂—;
m is in the range of 0 to 100; and
n is in the range of 0 to 100.

17. A process for the preparation of a phosphate ester of formula (I) used as a dispersion promoting agent 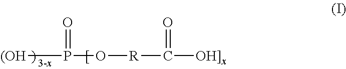
in which
R independently represents, at each occurrence, a polyester residue containing in its skeleton optionally at least one ether oxygen atom —O—; and
x is 1 or 2,
the process comprising:
(i) providing at least one hydroxyl compound containing a free carboxylic acid group represented by the general formula (II) 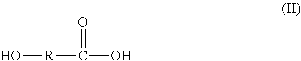
in which
R is defined as above; and
(ii) performing esterification of the hydroxyl compound with a phosphating agent, thereby forming the phosphate ester used as a dispersion promoting agent.

18. The process according to claim 17, wherein providing the hydroxyl compound containing a free carboxylic acid group comprises providing a hydroxyl compound containing a free carboxylic acid group having the structure represented by formula (II-1) or (II-2) by esterification of at least one hydroxycarboxylic acid and/or its lactone, or by esterification of at least one dicarboxylic acid or polycarboxylic acid with at least one diol in a 1:1 or greater molar equivalent ratio of the acid to the diol: 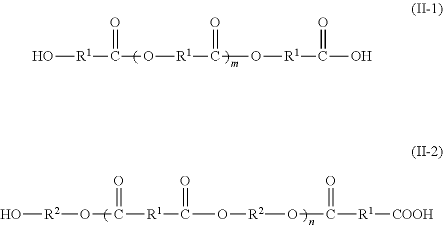
in which
each R¹ independently represents, at each occurrence, substituted or unsubstituted C₂-C₁₈ alkylene, substituted or unsubstituted C₂-C₁₈ alkenylidene, or substituted or unsubstituted C₆-C₁₈ arylene;
each R² independently represents, at each occurrence, C₂-C₁₈ alkylene; —(CH₂CH₂O)ₚCH₂CH₂—, in which p is in the range of 1 to 6; or —(CH₂CH₂CH₂O)_{q}CH₂CH₂CH₂—, in which q is in the range of 1 to 6; or —R″O(CH₂CH₂O)ₚ(CH₂CH₂CH₂O)_{q}R″—, where p and q are as defined above, the structural units are connected with each other randomly, and R″ is —CH₂CH₂— or —CH₂CH₂CH₂—;
m is in the range of 0 to 100; and
n is in the range of 0 to 100.

19. The process according to claim 18, wherein the hydroxycarboxylic acid comprises 12-hydroxystearic acid, ricinoleic acid, 12-hydroxydodecanoic acid, 5-hydroxydodecanoic acid, 5-hydroxydecanoic acid, 4-hydroxydecanoic acid, glycolic acid, lactic acid, 6-hydroxyhexanoic acid or 5-hydroxypentanoic acid.

20. The process according to claim 18, wherein the lactone comprises propiolactone, butyrolactone, δ-valerolactone, ε-caprolactone, or C₁₋₁₈ alkyl substituted ε-caprolactone.
